(19) United States
(12) Patent Application Publication
(10) Pub. No.: US 2004/0173085 A1
(43) Pub. Date: Sep. 9, 2004

(54) Musical keyboard system for electronic musical instrument

(76) Inventors: Phoei Min Seow, Singapore (SG); Kok Liang Lim, Singapore (AU); Wong Hoo Sim, Singapore (SG)

Correspondence Address: Stephen M. De Klerk, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/382,284

(22) Filed: Mar. 4, 2003

(51) Int. Cl. G10H 1/32; G10H 3/00

(52) U.S. Cl. 84/744

(57) ABSTRACT

A musical keyboard system for an electronic musical instrument, the keyboard system including a sensor arrangement for determining the amplitude of a note produced by a key of the musical keyboard, the sensor arrangement including a first sensor for providing an indication of a first time when movement of the key activates the first sensor, a second sensor for providing an indication of a second time when movement of the key activates the second sensor, a calculating device for determining the time difference between the second time and the first time, and an amplitude determining device for determining into which range of a plurality of ranges of time differences the time difference falls, and which amplitude of a plurality of amplitudes corresponds to the range. A corresponding method is also disclosed.

### FIELD OF THE INVENTION

The present invention relates to a musical keyboards system for electronic musical instruments and refers particularly, though not exclusively, to electronic keyboard musical instruments having a keyboard that is a MIDI or quasi-MIDI keyboard such as, for example, electric organs, electric pianos, synthesizers, and so forth.

### BACKGROUND OF THE INVENTION

The music industry has evolved from an analogue world to a digital world. A standard for a serial interface for music synthesizers, musical instruments, and computers has resulted, and has gained wide acceptance. That standard is the Musical Instrument Digital Interface (“MIDI”). A MIDI keyboard is one that complies with the MIDI standard. A quasi-MIDI keyboard is one that complies with most, but not all, aspects of the MIDI standard but operates as if it does comply with the MIDI standard. The principal use of MIDI keyboards has been in electronic pianos, electronic organs and synthesizers.

When playing a manual piano the force and speed with which a key is struck determines the force and speed with which the corresponding hammer strikes the strings. This determines the volume of the note produced by the piano.

With electronic keyboard musical instruments such as electronic pianos, electronic organs and synthesizers, it has generally not been possible to incorporate such volume functionality. As a result, in many cases volume controls external to the keyboard have been used. An example of such an external volume control is a pedal.

### SUMMARY OF THE INVENTION

In a preferred form, there is provided a musical keyboard system for an electronic musical instrument, the keyboard system including a sensor arrangement to determine the amplitude of a note produced by a key of the electronic musical instrument, the sensor arrangement including a first sensor for providing an indication of a first time when movement of the key activates the first sensor, a second sensor for providing an indication of a second time when movement of the key activates the second sensor, a calculating device for determining the time difference between the second time and the first time, and an amplitude determining device for determining into which range of a plurality of ranges of time differences the time difference falls, and which amplitude of a plurality of amplitudes corresponds to the range.

The first sensor and the second sensor may be contacted by a key base of the key to provide the first and second time indications, respectively. The first sensor and the second sensor may be mounted in a spaced-apart relationship. The spacing of the first sensor and the second sensor may be set and known. The first sensor and the second sensor may be spaced apart vertically and/or horizontally. The sensors may be horizontally spaced apart longitudinally and/or laterally of the key. The first sensor may be of height greater than that of the second sensor. The first sensor may be biased towards the key and may be able to move with the key until the key activates the second sensor.

The first sensor and second sensor may be mounted within a buffer mat, the buffer mat being mountable on a base of the musical keyboard. Alternatively, the first sensor and the second sensor may be mounted between the base and the buffer mat.

The number of ranges of the plurality of ranges of time differences may be the same as or different to the number of the amplitudes. Preferably, the number of ranges is fifteen, and the number of amplitudes is five.

The amplitude-determining device may be a look-up table containing the plurality of ranges of time differences and the plurality of amplitudes.

The first sensor may be located towards an outer end of the key, and the second sensor may be located towards an inner, pivoting end of the key, the second sensor being of a height greater than a height of the first sensor.

In another preferred form, there is provided a method for determining an amplitude for a note to be produced as a result of the pressing of a key of a musical keyboard of an electronic musical instrument, the method including the steps:

a. determining a first time at which movement of the key activates a first sensor to provide an indication of the first time;

b. determining a second time at which movement of the key activates a second sensor to provide an indication of the second time;

c. calculating a time difference between the second time and the first time; and

d. determining into which range of a plurality of ranges of time differences the time difference falls;

e. determining which amplitude of a plurality of amplitudes corresponds to the range in which the time difference falls; and

f. extracting the amplitude.

The number of ranges of the plurality of ranges of time differences may be the same as or different to the number of the amplitudes. The number of ranges may be fifteen, and the number of amplitudes may be five.

There may be provided a look-up table such as a matrix table containing the plurality of ranges of time differences and the plurality of amplitudes.

After step (f) there is preferably performed an additional step of sending a signal to a sound card advising the sound card of the amplitude for the note. A base of the key may be used to activate the first and second sensors to activate the first and second times, respectively. The first and second sensors may be horizontally spaced apart longitudinally and/or laterally of the key.

In a final, preferred form, the present invention provides a musical keyboard system for an electronic musical instrument, the keyboard system including:

a sensor arrangement for determining an amplitude of a note produced by the pressing of a key of the musical keyboard, the sensor arrangement including:

a first sensor for providing an indication of a first time when movement of the key activates the first sensor;

a second sensor for providing an indication of a second time when movement of the key activates the second sensor;

a calculator for determining the time difference between the second time and the first time;

a look-up table for determining into which range of a plurality of ranges of time differences the time difference falls, and which amplitude of a plurality of amplitudes corresponds to the range, the number of ranges of the plurality of ranges of time differences being different to the number of the of amplitudes.

The first sensor and the second sensor may be contactable by a key base of the key to provide the first and second time indications, respectively.

The first sensor and the second sensor both may be mounted on a base in a vertically and horizontally spaced apart relationship by a distance that is set and known; and the first sensor may be able to move with the key after actuation of the first sensor by the key until the key activates the second sensor.

The present invention also provides an electronic keyboard musical instrument incorporating such a musical keyboard system; a computer useable medium comprising a computer program code that is configured to cause a processor to execute one or more function for performing the method described above; and an electronic keyboard musical instrument programmed with that computer program code.

### DESCRIPTION OF THE DRAWINGS

In order that the invention may be readily understood and put into practical effect, there shall now be described by way of non-limitative example only preferred embodiments of the present invention, the description being with reference to the accompanying illustrative drawings in which:

FIG. 1 is a perspective view from one end of a keyboard according to a first aspect of the present invention;

FIG. 2 is an illustration of a first form of the present invention;

FIG. 3 is an illustration of a second form of the present invention, from the other side;

FIG. 4 is an illustration of a third form of the present invention as seen from an outer end of the key;

FIG. 5 is an illustration of a fourth form of the present invention;

FIG. 6 is an example of a look-up table for the system of FIGS. 2 to 5; and

FIG. 7 is a flow chart for the operation of the forms of FIGS. 2 to 5.

### DESCRIPTION OF PREFERRED EMBODIMENTS

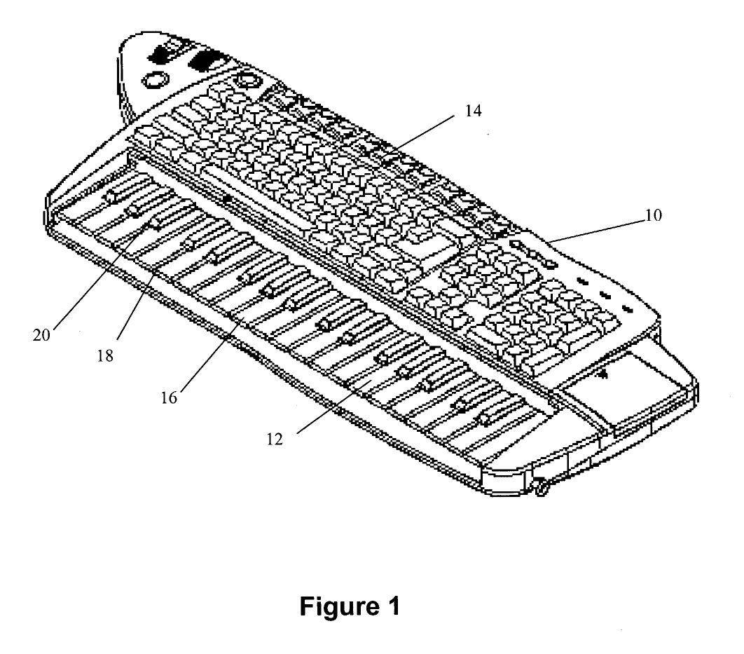

In FIG. 1 there is shown a combined keyboard 10 as described and defined in our earlier application PCT/SG01/00040 (“our earlier application”). Although the present invention is applicable to the combined keyboard 10 as illustrated in our earlier application, it can be used with a musical keyboard for any electronic musical instrument such as, for example, an electronic organ, electronic piano, or synthesizer. The combined keyboard 10 has a musical keyboard 12 and an alphanumeric (QWERTY) keyboard 14. The musical keyboard 12 may be a MIDI keyboard, quasi-MIDI keyboard, or may be according to any other relevant system or standard for musical keyboards of electronic musical instruments. The musical keyboard 12 includes a plurality of musical keys 16 including “white” keys 18 and “black” keys 20.

The present invention also relates to a method of measuring inputs of varying magnitude on such a keyboard and associating to those inputs an audio output of corresponding loudness from any sound production device such as, for example, a sound card (internal or external) with respect to the musical keys.

The time difference between the activation by a musical key of two sensors placed at a specific distance apart, is measured. This time difference, which differs each time the musical key is struck with varying intensity of force, is then translated to an electronic output with varying amplitude. The electronic output is used to produce the intended loudness response via a matrix detailing the corresponding audio loudness output from inputs of varying magnitude.

To refer to the remaining drawings:

d₁ is the distance between the base of the key and the top of sensor 1;

d₂ is the distance between the base of the key and the top of sensor 2;

Δd is the difference between d₁ and d₂;

t₁ is the time taken for the base of the key to hit sensor 1;

t₂ is the time taken for the base of the key to hit sensor 2; and

Δt is the difference between t₁ and t₂.

Therefore:

Δt=t₂−t₁,

Δd=d₂−d₁

As displacement=½ (acceleration×Time²)

Δd=½(a×Δt²)

Since Force (“F”)=mass (“m”)×acceleration (“a”)

F=m×2Δd÷Δt²

Force is therefore inversely proportional to the square of Δt.

The time measurement, including t₁, t₂ and Δt, may be in system clock counts.

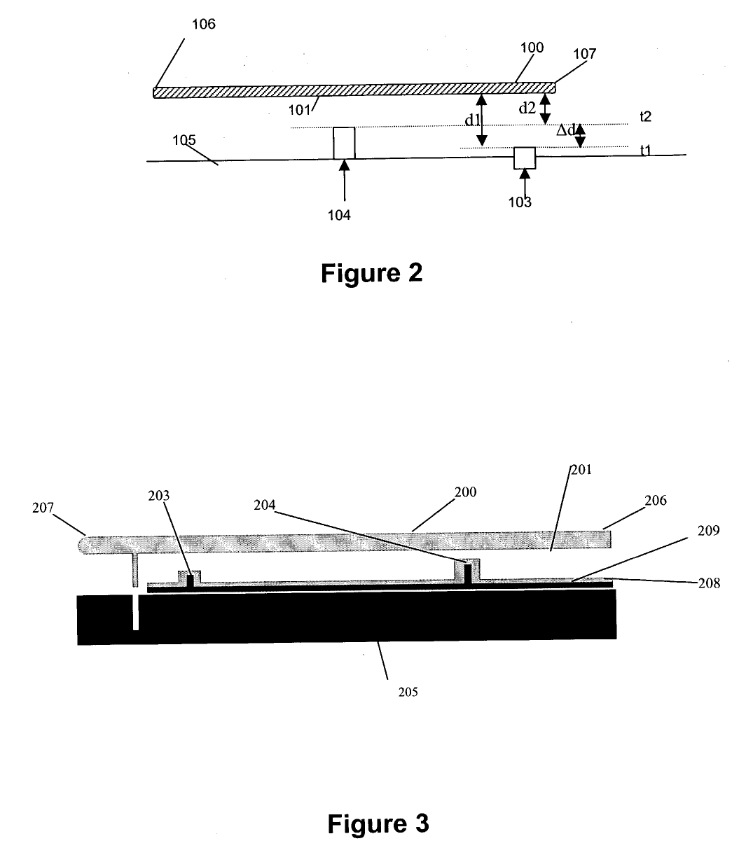

In FIG. 2, the distance Δd between the two sensors 103, 104 is set and known. The time Δt taken for the key 100 to pass from the first sensor 103 to the second sensor 104 depends upon the spatial relationship of the two sensors 103, 104 and the force with which the key is struck. The spatial relationship between the two sensors 103, 104 depends on the vertical difference Δd and their respective horizontal positions relative to the base 105 of the keyboard 12. Both Δd and the respective horizontal positions are known. As the time Δt is measured, it gives a time difference that is proportional to the speed of movement of the key 100. The speed of movement of the key 100 is proportional to the force with which it is struck. The force determines the required loudness/volume/amplitude. For simplicity this will henceforth be called “amplitude”. Therefore, the required amplitude is inversely proportional to Δt. The shorter Δt, the greater is the required amplitude, and the longer Δt the lower the required amplitude.

Therefore, when the user strikes the key 100, the base 101 of the key 100 strikes or passes the first sensor 103 mounted on base 105 and the application notes the time t₁ at which this takes place. The key 100 continues its pivotal motion until the base 101 of the key 100 strikes or passes the second sensor 104 also mounted on base 105 and the application notes the time t₂ at which this takes place. The first sensor 103 should be contacted first. The keyboard is pivoted at the left end 106 as shown. The application calculates the time difference At between t₂ and t₁ and passes the time difference to the central processor of the instrument.

In the central processor there is a table of relationships between time differences Δt and the required amplitude. The time differences Δt may be recorded as a series of ranges of time differences Δt with each range having a relevant amplitude. In this way the processor can determine the required amplitude more quickly as it only has to determine into which range the time difference Δt falls, locate the required range for the time difference Δt, and determine the required amplitude. The number of ranges of time differences Δt may be fixed at any desired number such as, for example 5, 10, 15 or 20. The number of amplitude settings corresponding to the ranges of time difference Δt may be the same as the number of ranges of time differences Δt, or may be different. For example, if there are ten ranges of time differences Δt there may be ten amplitude settings, or there may be only four amplitude settings; or if there are fifteen ranges of time differences Δt there may be only five amplitude settings. In this way processor speed is maximized, and the delay between a user hitting a key 100 and the corresponding sound being produces is also minimized. Preferably, the table is a matrix table of time differences, and corresponding amplitude settings. The amplitude is extracted and is passed to the sound card to enable the correct volume to be created and played.

The sensors 103, 104 may be spaced apart horizontally, as shown. The horizontal spacing may be longitudinally of the key 100—along or generally parallel to the longitudinal axis of the key 100. Additionally, they may be spaced apart vertically. With the key 100 moving in an arcuate manner, being spaced apart both horizontally and vertically allows for the control of the distance difference Ad and for the maximum distance difference Δd to thus maximize the time difference Δt. This may minimize errors in the time difference Δt and thus provide a more accurate amplitude and thus volume. It also reflects that the second sensor 104 may need to be at a greater height due to the arcuate movement of key 100. Alternatively, the first sensor 103 may be at a greater height than second sensor 104, or the two sensors 103, 104 could be at the same height. The two sensors 103, 104 may be spaced apart horizontally by a relatively large distance so the first sensor 103 is located towards the outer end 107 of key 100, and second sensor 104 is located towards the inner/pivoting end 106 of key 100.

In FIG. 3 like components use like reference numerals but with a prefix number 2 rather than 1. As shown in FIG. 3, there is provided a buffer mat 208 of rubber or similar material on base 205. This is so that when key 200 is struck, its outer end 207 contacts mat 208 rather than base 205 to thus dampen the movement, and to reduce any noise produced by the contact. Sensors 203, 204 may be incorporated into the mat 208 so that, again, contact of sensors 203, 204 by base 201 of key 200 will be dampened, and relatively silent. The required contacts for sensors 203, 204 may be in a layer 209 located between mat 208 and base 205. Alternatively, the sensors 203, 204 may be under mat 208 and mounted on base 205.

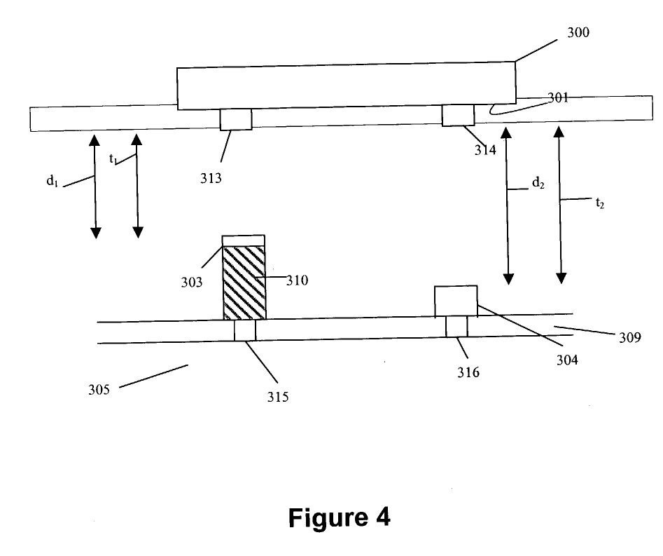

The embodiment in FIG. 4 uses similar reference numerals but with a prefix number of 3 rather than 1 or 2. Here there is provided a base 305 of the keyboard, and on which are mounted a first sensor 303 and second sensor 304. First sensor 303 is biased towards key 300 by any known means such as, for example, a spring 310 (as shown). First sensor 303 can move vertically with key 300 after contact by key 300 until key 300 contacts second sensor 304. Sensors 303, 304 are horizontally spaced apart laterally of key 300, and are vertically spaced apart with first sensor 303 higher than second sensor 304.

The underneath 301 of key 300 may have first and second pads 313 and 314 for first and second sensors 303, 304 respectively. Layer 309 includes first and second contacts 315, 316 for first sensor 303 and second sensor 304 respectively.

Although the form of FIG. 4 is as viewed from an end of the key 300, it is equally applicable if the sensors 303, 304 were arranged longitudinally of the key 300 provided the first sensor 303 is contacted by the base 301 of key 300 before the base 301 of key 300 contacts the second sensor 304.

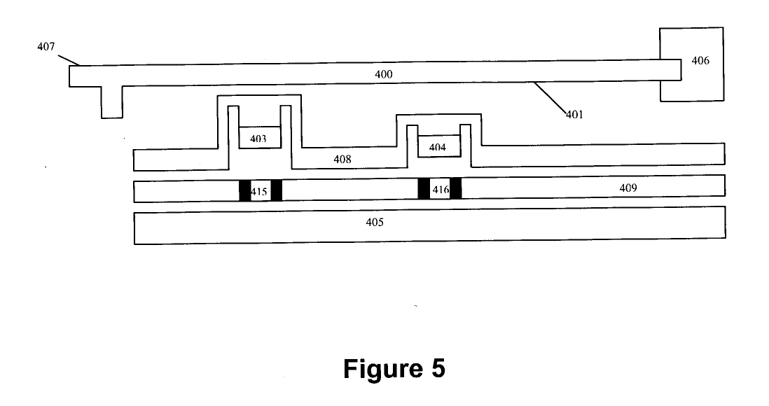

The embodiment in FIG. 5 uses similar reference numerals but with a prefix number of 4 rather than 1, 2 or 3. This embodiment is similar to that of FIGS. 2 and 3, but with the sensor arrangement such that first sensor 403 is closer to base 401 of key 400 than second sensor 404 when key 400 is in the rest position (as shown). Alternatively, the two sensors 403 and 404 may be the same distance from the base 401 of key 400.

Here there is provided a base 405 of the keyboard, on which is layer 409. To layer 409 are mounted the first sensor 403 and second sensor 404. First sensor 403 is biased towards key 400 by any known means such as, for example, a spring, or by the resiliency of the mat 408. First sensor 403 can move vertically with key 400 after contact by base 401 of key 400 until base 401 of key 400 contacts second sensor 404. Sensors 403, 404 are horizontally spaced apart longitudinally of key 400.

There is again provided a buffer mat 408 of rubber or similar material on base 405. This is so that when key 400 is struck, its outer end 407 contacts mat 408 rather than base 405 to thus dampen the movement, and to reduce any noise produced by the contact. Sensors 403, 404 may be incorporated into the mat 408 so that, again, contact of sensors 403, 404 by base 401 of key 400 will be dampened, and relatively silent. The required contacts 415, 416 for sensors 403, 404 respectively may be in layer 409 located between mat 408 and base 405. Alternatively, the sensors 403, 404 may be under mat 408 and mounted on layer 409.

Due to the accurate movement of key 400 about 406, the vertical component of movement of key 400 at first sensor 403 is greater than at second sensor 404. Therefore, base 401 of key 400 contacts first sensor 403 before second sensor 404, thus creating At. Therefore, the spatial relationship between first and second sensors may be due to either or both of: their longitudinal, horizontal spacing, and their vertical difference Δd.

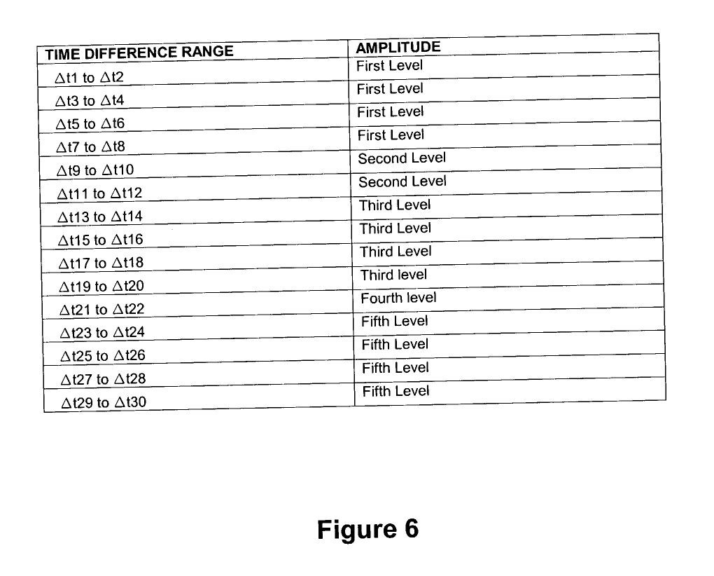

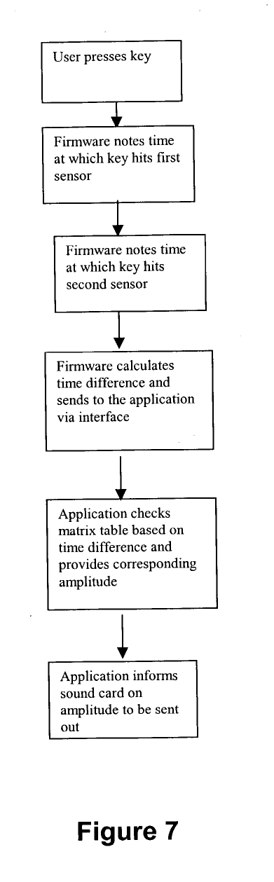

In FIG. 6 an example of table is provided. Here there are fifteen different time difference ranges given as Δtn to Δt(n+1). The ranges may all be relatively the same, or may be quite different, or may be a combination of the two. Five different amplitude levels are given, although that number is merely exemplary. As shown, the amplitude levels are not applied equally. They may be applied equally—as in three adjacent, different time difference ranges for each given amplitude level. Alternatively, the first four time difference ranges may each have a different amplitude level, and all subsequent time difference ranges all have the same amplitude level. The first time difference range may be set at close to zero thus representing a very fast keystroke and consequently a high amplitude. This may be varied by user input, or may be preset. The various amplitude levels may correspond to the more commonly used levels for commonly used volumes. For example, level one may correspond to fortissimo, level two to forte, level three to mezzo forte, level four to piano, and level five to pianissimo.

When first sensor is activated by the base of the key the sensor may continue to move downwardly with the key. Therefore, the sensor may be of a category that allows vertical movement.

Although two sensors are disclosed, there may be more than two sensors if desired. Also, the sensors may be of any suitable nature or category. It is preferred that first sensor is activated as soon as the key commences its movement, and for second sensor to be activated shortly before, or as, the key completes its normal movement. This maximizes the time difference.

The calculation of the time difference may be performed in a calculator. The calculator may be one or more computational devices such as, for example, suitable programmed semi-conductor chips suitable programmed with an appropriate application to perform the required function. The semi-conductor chips may located in one or more of: the keyboard of the electronic musical instrument, the electronic musical instrument, or a separate computer. The determining of amplitudes may, as is stated above, be performed using a look-up table such as a matrix table. The look-up table may be stored in one or more computational devices such as, for example, semi-conductor chips suitably programmed with an appropriate application to perform the required function. The semi-conductor chips may be located in one or more of: the keyboard of the electronic musical instrument, the electronic musical instrument, and a separate computer the central processor for the keyboard system may include either or both of the calculator and the look-up table.

The present invention also extends to a computer useable medium comprising a computer program code that is configured to cause a processor to execute one or more function described above, and to a keyboard programmed with the computer program code. Whilst there has been described in the foregoing description preferred embodiments of the present invention, it will be understood by those skilled in the technology that many variations in design, construction or operation may be made without departing from the present invention.

The present invention extends to all features disclosed either individually or in all possible permutations and combinations.

1. A musical keyboard system for an electronic musical instrument, the keyboard system including:
a sensor arrangement for determining an amplitude of a note produced by the pressing of a key of the electronic musical instrument, the sensor arrangement including:
(a) a first sensor for providing an indication of a first time when movement of the key activates the first sensor,
(b) a second sensor for providing an indication of a second time when movement of the key activates the second sensor,
(c) a calculating device for determining the time difference between the second time and the first time, and
(d) an amplitude determining device for determining into which range of a plurality of ranges of time differences the time difference falls, and which amplitude of a plurality of amplitudes corresponds to the range.

2. A musical keyboard system as claimed in claim 1, wherein the first sensor and the second sensor are contactable by a key base of the key to provide the first and second time indications, respectively.

3. A musical keyboard system as claimed in claim 2, wherein the first sensor and the second sensor are mounted in a spaced apart relationship by a distance that is set and known, the first sensor and the second sensor being spaced apart by either or both of vertically and horizontally.

4. A musical keyboard system as claimed in claim 3, wherein the sensors are horizontally spaced apart longitudinally of the key.

5. A musical keyboard as claimed in claim 4, wherein the first sensor is located towards an outer end of the key, and the second sensor is located towards an inner, pivoting end of the key, the second sensor being of a height greater than a height of the first sensor.

6. A musical keyboard system as claimed in claim 3, wherein the sensors are horizontally spaced apart laterally of the key, the first sensor being of height greater than the second sensor.

7. A musical keyboard system as claimed in claim 6, wherein the first sensor is biased towards the key and is able to move with the key against the bias until the key activates the second sensor.

8. A musical keyboard system as claimed in claim 7, wherein the first sensor and second sensor are mounted within a buffer mat, the buffer mat being mountable on a base of the musical keyboard.

9. A musical keyboard system as claimed in claim 8, wherein the first sensor is biased towards the key due to resiliency of the buffer mat.

10. A musical keyboard system as claimed in claim 6, wherein there is provided a contact layer under the buffer mat, the contact layer including first contacts for the first sensor and second contacts for the second sensor.

11. A musical keyboard system as claimed in claim 1, wherein the number of ranges of the plurality of ranges of time differences is different to the number of the amplitudes.

12. A musical keyboard system as claimed in claim 11, wherein the number of ranges is fifteen, and the number of amplitudes is five.

13. A musical keyboard system as claimed in claim 1, wherein the amplitude determining device is a look-up table containing the plurality of ranges of time differences and the plurality of amplitudes.

14. A method for determining an amplitude for a note to be produced as a result of the pressing of a key of a musical keyboard of an electronic musical instrument, the method including the steps:
a. determining a first time at which movement of the key activates a first sensor to provide an indication of the first time;
b. determining a second time at which movement of the key activates a second sensor to provide an indication of the second time;
c. calculating a time difference between the second time and the first time;
d. determining into which range of a plurality of ranges of time differences the time difference falls;
e. determining which amplitude of a plurality of amplitudes corresponds to the range in which the time difference falls; and
f. extracting the amplitude.

15. A method as claimed in claim 14, wherein the number of ranges of the plurality of ranges of time differences is the same as the number of the of amplitudes.

16. A method as claimed in claim 14, wherein the number of ranges of the plurality of ranges of time differences is different to the number of the of amplitudes.

17. A method as claimed in claim 16, wherein the number of ranges is fifteen, and the number of amplitudes is five.

18. A method as claimed in claim 14, wherein there is provided a look-up table containing the plurality of ranges of time differences and the plurality of amplitudes.

19. A method as claimed in claim 18, wherein the look-up table is a matrix table.

20. A method as claimed in claim 14, wherein after step (f) there is preformed an additional step of sending a signal to a sound card advising the sound card of the amplitude for the note.

21. A method as claimed in claim 14, wherein a base of the key is used to activate the first and second sensors to activate the first and second times, respectively.

22. A method as claimed in claim 14, wherein the first sensor and the second sensor are horizontally spaced apart longitudinally of the key.

23. A method as claimed in claim 22, wherein the first sensor is located towards an outer end of the key, and the second sensor is located towards an inner, pivoting end of the key, the second sensor being of a height greater than a height of the first sensor.

24. A method as claimed in claim 22, wherein the first sensor and the second sensor are horizontally spaced laterally of the key, the first sensor being a height greater than that of the second sensor.

25. A method as claimed in claim 24, wherein the first sensor is biased towards the key and is able to move with the key against the bias until the key activates the second sensor.

26. A musical keyboard system for an electronic musical instrument, the keyboard including:
a sensor arrangement for determining an amplitude of a note produced by the pressing of a key of the musical keyboard, the sensor arrangement including:
a first sensor for providing an indication of a first time when movement of the key activates the first sensor;
a second sensor for providing an indication of a second time when movement of the key activates the second sensor;
a calculator for determining the time difference between the second time and the first time; and
a look-up table for determining into which range of a plurality of ranges of time differences the time difference falls, and which amplitude of a plurality of amplitudes corresponds to the range.

27. A musical keyboard system as claimed in claim 26, wherein the number of ranges of the plurality of ranges of time differences is different to the number of the of amplitudes.

28. A musical keyboard system as claimed in claim 26, where the first sensor and the second sensor are contactable by a key base of the key to provide the first and second time indications, respectively.

29. A musical keyboard system as claimed in claim 28, wherein the first sensor and the second sensor are both mounted on a base in a vertically and horizontally spaced apart relationship by a distance that is set and known; the first sensor being able to move with the key after actuation of the first sensor by the key until the key activates the second sensor.

30. An electronic keyboard musical instrument incorporating a musical keyboard system as claimed in claim 1.

31. A computer useable medium comprising a computer program code that is configured to cause a processor to execute one or more function for performing the method of claim 14.

32. An electronic keyboard musical instrument programmed with the computer program code of claim 31.
